(19) United States
(12) Patent Application Publication
(10) Pub. No.: US 2014/0094987 A1
(43) Pub. Date: Apr. 3, 2014

(54) TIERED LEVEL OF ACCESS TO A SET OF VEHICLES

(71) Applicant: INTEL CORPORATION, Santa Clara, CA (US)

(72) Inventors: Jennifer Healey, San Jose, CA (US); Alexandra Zafiroglu, Portland, OR (US); Tim Plowman, Berkeley, CA (US); Victoria Fang, Mountain View, CA (US); Philip Corriveau, Forest Grove, OR (US)

(73) Assignee: INTEL CORPORATION, Santa Clara, CA (US)

(21) Appl. No.: 13/629,914

(22) Filed: Sep. 28, 2012

(51) Int. Cl. B60R 25/00

(52) U.S. Cl. CPC B60R 25/00
USPC 701/1

(57) ABSTRACT

An access control system allows a plurality of users various tiered levels of access to a set of vehicles, records driving information and the purposes that the vehicles are driven, and provides reports to a select subsets of users.

### TECHNICAL FIELD

Aspects of the disclosure relate generally to vehicle access, and more particularly, to a tiered level of access to a set of vehicles amongst a set of people.

### BACKGROUND

In some places the average cost of a car exceeds the average annual household income. As a result a single car is often shared by an extended family which can also include a network of close friends. Collective ownership of cars is also common in Israel in kibbutzes. In the United States, this shared nature of vehicles often exists with respect to fleet vehicles. In certain situations, neighbors and carpools may share cars. In addition, the shared nature of a vehicle can be observed in some commercial rideshare solutions.

Especially in private circles, the co-ownership of cars is enmeshed in relationships of care and obligation within and across household-s. Either a single household has more than one car, or a single car is used by multiple households. Because these cars are used by the same people, the cars and the people that use them should be able to communicate and share information securely and privately and with personalized levels of access based on responsibilities. For example, some people may have full access to the car and others may have limited access. Information about necessary car maintenance may be shared differently than access permissions. In addition, tracking is needed of the obligation fulfillments utilizing the car such as running errands for others, picking up the children/relatives of others, filling the gas tank

Currently car access is solved with the solution of a key. Car obligations are usually tracked on paper or on stickers placed on the inside of the vehicle (for example the oil change sticker). Who gives rides to whom is generally solved by human memory and verbal communication.

### BRIEF DESCRIPTION OF THE FIGURES

Reference will now be made to the accompanying drawings, which are not necessarily drawn to scale, and wherein:

FIG. 1 is a block diagram of an access system in accordance with an example embodiment of the invention.

FIG. 2 is a block diagram of an example access system architecture that may be utilized in accordance with various embodiments of the disclosure.

FIG. 3 is flow diagram of an access control system for a vehicle in accordance with an example embodiment of the invention.

### DETAILED DESCRIPTION

In the following description, numerous specific details are set forth. However, it is understood that embodiments of the invention may be practiced without these specific details. In other instances, well-known methods, structures, and techniques have not been shown in detail in order not to obscure an understanding of this description. References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

As used herein, the term vehicle can refer generally to an automobile, car, truck, passenger vehicle, bus, motorcycle, or the like.

According to example embodiments of the invention, a multi-person personalized circle of kinship allows various levels of access to a vehicle, keeps track of how a vehicle is driven on behalf of others, and shares information regarding maintenance and driving infractions across select subsets of the circle.

In place of a key and currently human held records of who had access to the vehicle, under what conditions and for what purpose, a software construct referred to as a circle of kinship will maintain an active record of who has access to the vehicle, for what purpose and within what limitations (in state, in parking lot, valet, full access). This circle may also keep track of the vehicle's location, the current driver, current passengers, trip logs, and current vehicle state in terms of maintenance, fuel level, and potential damage.

A vehicle or set of vehicles may have multiple persons that has access to the vehicle(s). This access might be full access or limited driving access. Limited access may reduce vehicle privileges of a driver to a restricted range, restrict the number of passengers, restricted hours, and the like. Certain drivers may be subject to monitoring such as teens, elders and valets. An additional set of drivers may be granted access in emergency situations, such as if a babysitter needing to drive a child to the hospital or allow very limited access in case a neighbor is needed to move an illegally parked vehicle.

Beyond access, the access control system may also maintain the records of driver activity and to whom it is reported. The primary owners may restrict who can know about their personal activity and yet have extended rights to know about the activity of others. This access can be used for monitoring purposes and also for recording who has contributed to “obligation” driving such as doing errands and driving others.

Another aspect of the access control system is distribution of the responsibility of required maintenance for the vehicle that is shared amongst multiple drivers. Drivers who fulfill maintenance responsibilities such as getting the vehicle washed or oil changed may be credited.

Credits may earn an individual increase rights associated with the vehicle. Reports of who damages the vehicle may also be logged.

A tiered, encrypted permissions structure is stored in the vehicle, in phones, or externally using a secure wireless communication network. The access control system provides authentication to unlock, drive, guide, maintain and report on information about the vehicle. A vehicle is no longer exclusively accessed and controlled by a physical key, but by permissions and reporting structure that reflects the true nature of vehicle ownership.

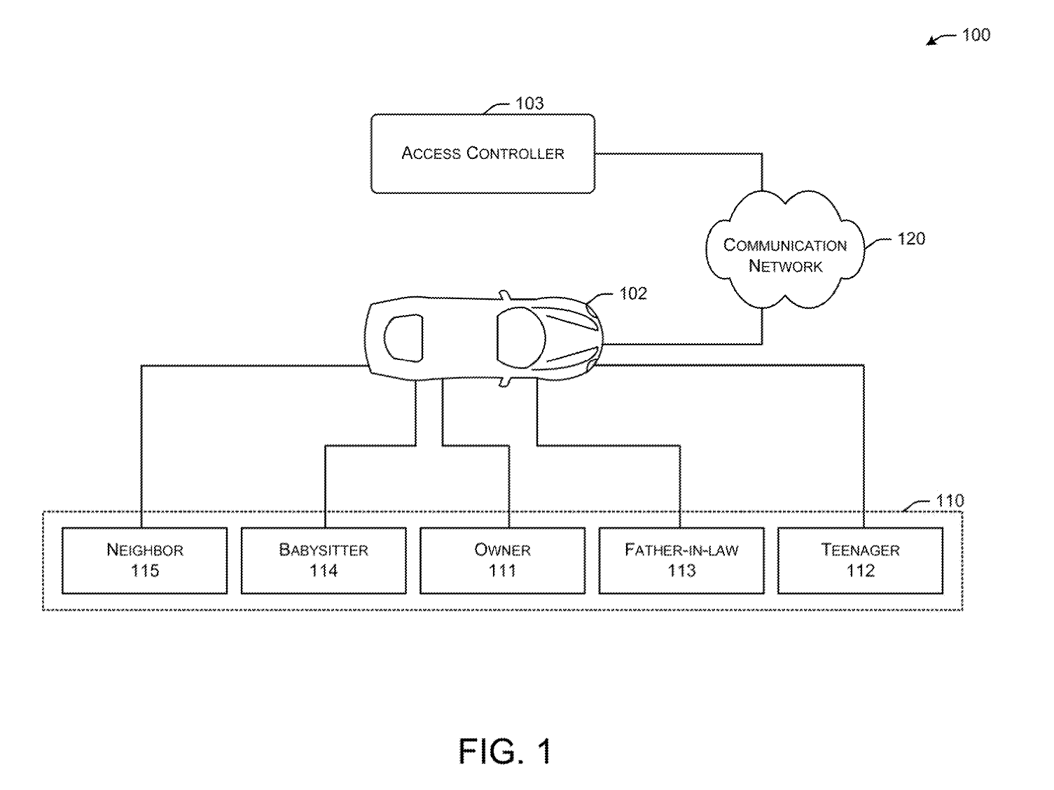

FIG. 1 is a block diagram of an access system 100 in accordance with an example embodiment of the invention. In the example embodiment, multiple users 110 have a tiered level of access to a vehicle 102. The access system 100 manages a personalized circle of kinship that allows various levels of access to a vehicle, keeps track of how a vehicle is driven on behalf of others and shares information regarding maintenance and driving infractions across select subsets of the circle.

In the illustrated embodiment, the access controller 103 manages a software construct that governs the access of vehicle 102 by a plurality of users 110. The access controller 103 has hardware and software for managing a tiered, encrypted permissions structure that is used to unlock, drive, guide, maintain and report on information about the vehicle 102. The access controller 103 has modules for identifying the users, controlling access, recording information, and generating notifications. The vehicle 102 is no longer exclusively accessed and controlled by a physical key, but by an access controller 103 that reflects the true nature of vehicle ownership. The access controller 103 or components thereof may be stored in the vehicle 102, in smart devices, and in remote servers. A wireless communication network 120 may be used to communicate the tiered, encrypted, permissions associated with each user 110.

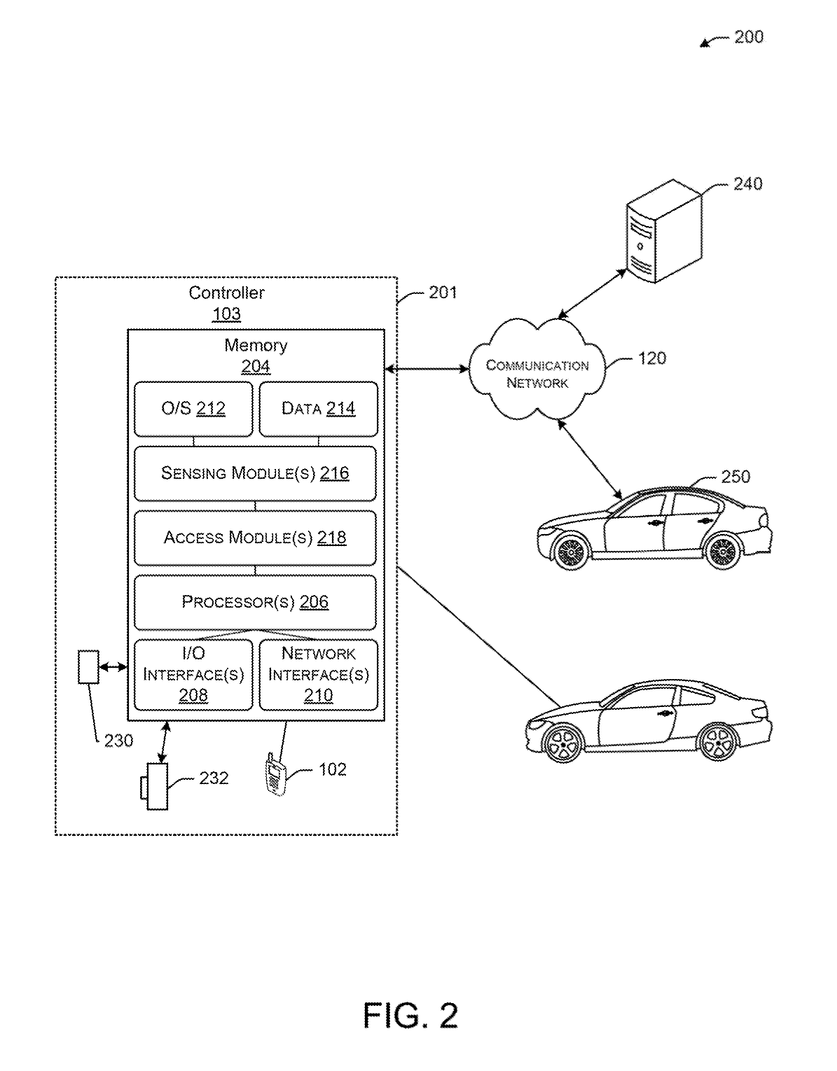

The access system 100 is operable to identify at least one user 110 of vehicle 102, such as a driver. A wide variety of suitable methods and/or techniques may be utilized to identify a user as disclosed in reference to FIG. 2. Upon identifying a user, the access system 100 grants or denies access to the vehicle 102. It is not necessary that the access system identify the driver to grant access to the vehicle 102. For example, if the access system identifies a minor child, the system may grant access to the vehicle 102 for the minor to be driven to a hospital or other locations associated with the child.

The access system 100 may grant reduced vehicle privileges to certain users 110. For example, a teenager 112 may have numerous restrictions in accessing the full functionality of the vehicle 102. For example, the reduce privileges may include driving the vehicle in a restricted range, restricted maximum speed of travel, restricting the number of passengers, or restricting the hours the teenager 112 may be allowed to drive. In addition to driving functionality, the access system may restrict the teenager 112 access to other functionality associated with the vehicle 102. For example, the teenager 112 may be restricted from listening to the radio or operating an entertainment system unless the teenager 112 is performing a task or obligation for the owner 111.

In another example, a babysitter 114 may be granted limited functionality. The babysitter may be restricted in the hours and geographic area that the vehicle may be allowed to driven. For example, the babysitter 114 may be allowed to drive the vehicle to sport events, school events, hospital, or neighborhood friends of the child. The babysitter 114 may have imposed a maximum speed of travel. Outside of the allowed uses, the access controller 103 may deny the user 110 the privilege to use the vehicle 102.

In yet another example, a father-in-law 113 may have a habit of driving on restricted days and incurring fines. Accordingly, the access controller 103 may be configured to require a notification be sent to the owner 111 if the father-in-law 113 is attempting to drive and disallow access unless the access system 100 receives an authorization from the owner 111 of the vehicle 102. Alternately, the access controller 103 may restrict the father-in-law's 113 access. For example, if there are restrictions associated with the plate number, the vehicle 102 may not be allowed to drive during those restrictions. If the father-in-law 113 cannot see well at night, the access system 100 may disallow driving at night unless it is an emergency. In an emergency, the father-in-law 113 may need to provide an input indicating that there is an emergency and the access system 100 may generate a notification to the owner 111 or to a parent if the emergency is associated with a minor.

Like the babysitter 114, a neighbor 115 may be granted limited access. The neighbor may be restricted in the hours and geographic area that the vehicle 102 may be allowed to driven. For example, a neighbor 115 may only be allowed to move the vehicle 102 if it is illegally parked. If the neighbor sees an open legal parking space, the access system 100 may allow limited use to move the vehicle 102 to a legal packing location. Outside of the allowed uses, the access control may deny the user 110 the privilege of use of the vehicle 102.

In another example, the user 110 may provide an input to the access system 100 that he will be using a valet service. The valet driver might have limited range and limited number of miles allowed to be driven. The access system 100 may disable the vehicle 102 if the valet attempts to drive off the parking lot. In another embodiment, the access control system 100 may notify the local authorities and/or the owner 11 of the unauthorized use.

In another example, primary owner(s) 111 may have no restrictions of the use of the vehicle 102. Beyond access, the access system 100 may also generate records of driver activity and to whom it is reported. The primary owner(s) 111 may restrict who can know about their activity and have extended rights to know about the activity of others. This access can be used for monitoring and also for recording who has contributed to “obligation” driving such as doing errands and driving others. For example, as the primary owner 11 of the vehicle 102, no one else may have access to the primary owner's driving activity, unless it recorded for purposes of gaining “credit” for obligation driving. However, if the vehicle is loaned to a father-in-law 113, the owner 111 may want the father-in-law's 113 activity tracked. For example, the father-in-law 113 may have a habit of driving on restricted days and incurring fines. Accordingly, the access controller 103 may be configured to require a notification be sent to the primary owner 111 if the father-in-law 113 is driving and restrict his access on days when there is a restriction associated with the plate number. Reports of who damages the vehicle may also be logged.

Another aspect of the access system 100 is distribution of the responsibility of maintenance for the vehicle 102 that is shared amongst multiple users 110. Users 110 who fulfill maintenance responsibilities such as getting the vehicle 102 washed or oil changed may be credited. Credits may also be earned for performing driving obligations such as running errands or driving a brother or sister to their events. Credits may earn an individual increase rights associated with the vehicle 102. For example, the teenager 112 may earn enough credits that the access system will allow the teenager 112 to drive on a Friday night when the standard rule is that the teenager 112 is prohibited from driving at night. Alternatively, credits may allow the teenager 112 to listen to the radio or access some other denied functionality of the vehicle 102.

Another aspect of the access system 100 is logging who damages the vehicle or receives citations. In some embodiments, the receipt of a citation can be determined by the vehicle stopping along a highway, the sensing the sound of a siren associated with the stopping of the vehicle 102, an in-vehicle camera detecting the flashing of blue lights, or other means.

The access system 100 described above with reference to FIG. 1 is provided by way of example only. As desired, a wide variety of other systems and embodiments may be utilized to control access to a vehicle and generate associated reports. These systems may include different technologies, users, and methodologies than that illustrated in FIG. 1.

FIG. 2 illustrates a configurable vehicle access system 200 architecture, according to an example embodiment. The access system 200 may include certain components 201 that may be attached to, integrated within, or otherwise associated with a vehicle 102. As desired, the access system 200 may include any number of suitable computing devices associated with suitable hardware and/or software for processing. In certain embodiments, the access system 200 may be implemented or embodied as an independent access system built into a vehicle or a system brought into a vehicle 102. In other embodiments, the access system 200 may be implemented or embodied as a component of another system or device within a vehicle 102 such as an in-vehicle infotainment (“IVI”) system associated with a vehicle 102.

The system, may include one or more processors 206, memory devices 204 (generally referred to as memory 204), input/output (“I/O”) interfaces 208, and/or network interfaces 210 (e.g. data bus interfaces). A wide variety of various applications and/or devices may be in communication with the processors 206 via the communications interfaces 210 and as desired, any number of suitable communication networks 120.

The processors 206 may include any number of suitable processing devices, such as a central processing unit (“CPU”), a digital signal processor (“DSP”), a reduced instruction set computer (“RISC”), a complex instruction set computer (“CISC”), a microprocessor, a microcontroller, a field programmable gate array (“FPGA”), or any combination thereof. As desired, a chipset (not shown) may be provided for controlling communications between the processors 206 and one or more of the other components of the access system 200. The processors 206 may also include one or more processors as part of one or more application-specific integrated circuits (“ASICs”) or application-specific standard products (“ASSPs”) for handling specific data processing functions or tasks.

The memory 204 may include any number of suitable memory devices, such as caches, read-only memory devices, random access memory (“RAM”), dynamic RAM (“DRAM”), static RAM (“SRAM”), synchronous dynamic RAM (“SDRAM”), double data rate (“DDR”) SDRAM (“DDR-SDRAM”), RAM-BUS DRAM (“RDRAM”), flash memory devices, electrically erasable programmable read only memory (“EEPROM”), non-volatile RAM (“NVRAM”), universal serial bus (“USB”) removable memory, magnetic storage devices, removable storage devices (e.g. memory cards), and/or non-removable storage devices. As desired, the memory 204 may include internal memory devices and/or external memory devices in communication with the access system 200. The memory 204 may store data, executable instructions, and/or various program modules utilized by the processors 206. Examples of data that may be stored by the memory 204 include data files 214, any number of suitable program modules and/or applications that may be executed by the processors 206, such as an operating system (“OS”) 212, one or more access modules 218, and/or one or more sensing modules 216.

According to an example embodiment, the access controller 103 may also include a network interface 210. The network interface may be utilized for communication with a user device 220, such as a cell phone, laptop, key fob, RFID. According to an example embodiment, the network interface 210 may be utilized for communicating wirelessly to a remote server 240 via a communication network 120. In certain embodiments, communication may be established via any number of suitable networks (e.g. a Bluetooth-enabled network, a Wi-Fi network, a cellular network, a wireless network) with any number of user devices 220, such as mobile devices and/or tablet computers. According to certain example embodiments, the access controller 103 may be in communication with another vehicle 250 via the communication network 120.

The I/O interfaces 208 may facilitate communication between the processors 206 and any number of suitable input and/or output devices. Examples of suitable input/output devices include in-vehicle cameras 232 for capturing images within the vehicle 102 for determining the identity of one or more occupants and other sensors 230. For example, the sensors 230 may include a weight measurement device for identifying occupants of the vehicle 102 based, at least in part, on weight. In an example embodiment, the sensors 230 may include a microphone for receiving audible information, such as a voice response from one or more occupants of the vehicle 102. The I/O interfaces 208 may receive vehicle parameter information such as speed, direction, miles traveled Other examples of the sensors 230 may include other biometric readers, RFID readers, bar code readers, memory stick readers, global positioning system (GPS) sensors, Bluetooth readers, smart keys, near field communication (NFC) sensors

The data files 214 may include any suitable data that facilitates the operation of the access system 200 and/or communication between various components of the access system 200. For example, the data files 214 may include identification information and/or network address information associated with other components of the access system 200 and/or any number of external devices or systems, information that may be utilized to identify one or more users (e.g. stored image data, voice samples), vehicle location information, other vehicle parameters, and information associated with access control information (e.g. user profile information, user devices 220). The user profile information may include a wide variety of user identification information and/or parameters associated with one or more users. For example, the user profile information may include user identification information, geographic area in which a user is allowed to operate the vehicle 102, time of day that a user is allowed to operate the vehicle 102, functionality of the vehicle that a user is allowed to access such as the radio or other entertainment devices, number of passengers that a user may be allowed to transport

The OS 212, may be a suitable module or application that facilitates the general operation of an access control system, as well as the execution of other program modules, such as the access modules 218 and sensing modules 216.

The sensing modules 216 that may be utilized by the one or more processors 206 interpret information obtained by the sensors 230, in-vehicle camera 232, or other data gathering device 230 within the vehicle 102, for example, to determine the identity of one or more occupants of the vehicle 102. For example, a voice sample of a user may be collected and compared to a stored voice sample. As another example, image data for the user may be collected and evaluated utilizing one or more suitable facial recognition techniques. As another example, other biometric inputs (e.g. fingerprints) may be evaluated to identify a user. As yet another example, a user may be identified based upon a determined pairing between the vehicle and a user device (e.g. a mobile device) or a personalized smart key, and/or based upon the receipt and evaluation of user identification information (e.g. a personal identification number) entered by the user. In operation, the sensing module 216 may be configured to receive location information, such as GPS coordinates, from a suitable location component, such as the GPS component 230. The sensing module 216 may include any suitable applications associated with monitoring a vehicle, including but not limited to, an application that monitors various vehicle parameters (e.g. speed, direction, miles traveled).

The access modules 218 may include any number of suitable software modules and/or applications that control a user's use of a vehicle 102. Additionally, the access module 218 may be configured to generate output information, such as display information including the location that a vehicle was operated, speed in which a vehicle was operated, number of riders, vehicle maintenance performed, accident information. The generated output may be communicated to one or more suitable displays for presentation to a user.

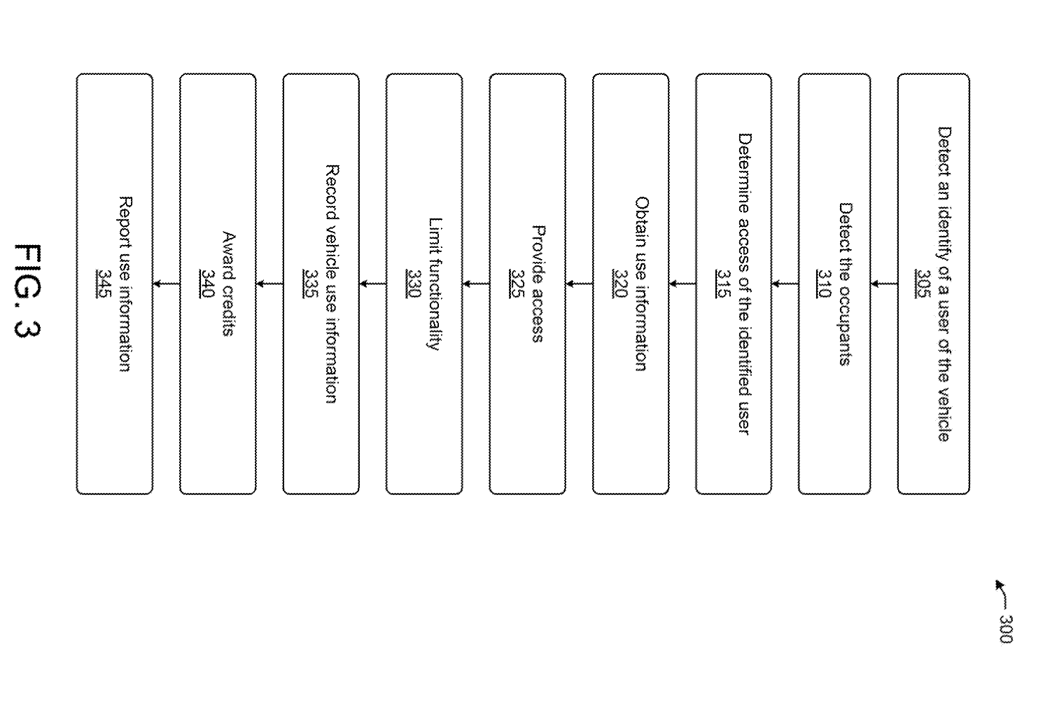

As desired, the access modules 218 and/or the sensing modules 216 may be implemented as any number of suitable modules. Alternatively, a single module may perform the combined functions described for the modules. A few examples of the operations of the modules are described in greater detail with reference to FIGS. 1 and 3.

The access system 200 or architecture described above with reference to FIG. 2 is provided by way of example only. As desired, a wide variety of other systems and/or architectures may be utilized to generate and output natural language inputs. These systems and/or architectures may include different components and/or arrangements of components than that illustrated in FIG. 1.

FIG. 3 is a flow diagram of an example method 600 for controlling the access of a vehicle. In certain embodiments, the operations of the method 600 may be performed by an access system and/or one or more associated modules and/or applications such as the sensing module(s) and access module(s) disclosed in FIG. 2. The method 600 may begin at block 605.

At block 605, an access system and/or one or more associated applications may be initiated in association with a vehicle. At least one user of the access system, such as a driver of the vehicle, may be identified. A wide variety of suitable methods and/or techniques may be utilized to identify a user. For example, a voice sample of a user may be collected and compared to a stored voice sample. As another example, image data for the user may be collected and evaluated utilizing one or more suitable facial recognition techniques. As another example, other biometric inputs (e.g. fingerprints) may be evaluated to identify a user. As yet another example, a user may be identified based upon a determined pairing between the vehicle and a user device (e.g. a mobile device) or a personalized smart key, and/or based upon the receipt and evaluation of user identification information (e.g. a personal identification number) entered by the user.

At block 610, occupant information within the vehicle is obtained. A wide variety of suitable methods and/or techniques may be utilized to determine the number and identities of the occupants. Identification of other occupants may utilize the method disclosed in connection of block 605. In order to determine the number of occupants, cameras may collect current image data and compare the results to standing rest data. In another embodiment, weight sensors can determine if there is an occupant in seat.

At block 615, the access level associated with at least one user is determined. Each user has a tiered access level associated with that user. The access system obtains a profile of each user. The profiles may be obtained by accessing an onboard controller or via a wireless system. The profile includes information on various restrictions of vehicle functionality for each user. The profile information may also include video information, audio information, other biometric information, smart device information, associated access codes, and other information that may be used in identification of the user.

At block 620, the system obtains use information. The user may input the use for the vehicle, inputs may include running of an errand, filing the vehicle with fuel, vehicle maintenance, transporting to a hospital, moving an illegally parked vehicle, and other tasks. The access system may obtain location information from an onboard navigation system, a GPS system, or any other position determining system. The location information may be used to determine if the vehicle needs to be moved such as from an illegal parking area. In addition, vehicle access may be restricted based upon geography such as the vehicle is out of state. The access system may also obtain the time. Numerous users may have time based restrictions. The access may also obtain the user's credits associated with gaining additional access privileges. Additional inputs may be obtained.

At block 625, based at least in part upon the identified user and a use if inputted, the system, grants or denies access to the vehicle. In addition, the access system may grant or deny access and notify a primary user. Alternatively the access system may request a primary user to authorize the use. The system may deny access based upon programmed restrictions such as the time of day, the use is not authorized for that user, or the user has insufficient credits for use of the vehicle. It is not necessary that the access system identify the driver in order to grant access to the vehicle. For example, if the access system identifies a minor child, the system may grant access to the vehicle for the minor to be driven to a hospital or other locations associated with the child.

At block 630, the access system limits the functionality of vehicle based in part on the user profile. For example, a radio or entertainment system may not be authorized and the system disables these functions. The system may engage a governor to limit the maximum speed the vehicle may travel. Additionally, in certain embodiments, a desired route, such as a route to an identified destination, may be required to be driven. If the user attempts to drive in an unauthorized area, the system may provide a notification to the driver. If the notification is ignored, the system may take various actions. For example, the system may greatly limit the maximum speed to very slow speed and notify the primary owner of the user's actions.

At block 635, the system begins recording vehicle parameters data. For example, the system may record location, speed, user, use, maintenance performed, if an accident has occurred, acceleration quickness from stops, de-acceleration quickness to a stop, and other data.

At block 640, if an errand or vehicle maintenance has been completed, the access system may award the user credits towards future use of the vehicle. For example, the owner may award a teen driver credits for driving their siblings to one of their functions. Credits may be awarded for obtaining required government vehicle inspections, filling the gas tank, or any other task determined by a primary user.

At block 645, the system may report use information to a primary user or other user. Reports may be generated during the use or after the use is completed. For example, location information associated with the vehicle may be recorded. As desired, a wide variety of other vehicle information may be recorded such as a speed, miles driven, and other suitable parameters.

The method 600 may end following block 640 awaiting the next access request.

The operations described and shown in the method 600 of FIG. 3 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 3 may be performed.

Certain aspects of the disclosure are described above with reference to block and flow diagrams of systems, methods, apparatus, and/or computer program products according to example embodiments. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified, in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, certain embodiments may provide for a computer program product, comprising a computer-usable medium having a computer-readable program code or program instructions embodied therein, said computer-readable program code adapted to be executed to implement one or more functions specified in the flow diagram block or blocks.

The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for enabling access to a vehicle, the method comprising:
detecting, by an access system comprising at least one processor, an identity of at least one occupant of the vehicle;
determining, by the access system, access level information based at least in part on a tiered encrypted permissions structure for controlling access to the vehicle by the at least one detected occupant identity; and
providing, by the access system, the at least one detected occupant access to the vehicle based upon the access level information.

2. The method of claim 1, further comprising limiting, by the access system, the at least one detected occupant access to certain functionality of the vehicle based upon the access level information.

3. The method of claim 2, wherein the certain functionality includes an ability to drive the vehicle.

4. The method of claim 2, wherein the certain functionality includes an ability to operate a vehicle entertainment device.

5. The method of claim 1, further comprising recording, by the access system, vehicle use information by the at least one detected occupant.

6. The method of claim 5, further comprising awarding, by the access system, the at least one detected occupant vehicle use credits based in part on the vehicle use information.

7. The method of claim 6, further comprising granting use of additional functionality of the vehicle based at least in part on the credits awarded.

8. The method of claim 1, wherein the access system is based within the vehicle.

9. The method of claim 1, wherein the at least one of the one or more processors that determines access level information is hosted external to the vehicle.

10. The method of claim 5, further comprising reporting, by the access system, the vehicle use information to at least one individual based upon a reporting rule.

11. The method of claim 1, wherein detecting the identity of the at least one occupant of the vehicle comprises one or more of:
comparing information associated with the at least one occupant that is acquired by one or more sensors associated with the vehicle with stored information to determine occupant identity.

12. A vehicle comprising:
one or more sensors for detecting an identity of an occupant of the vehicle;
at least one memory for storing data and computer-executable instructions;
at least one processor configured to access the at least one memory and further configured to execute the computer-executable instructions to:
detect an identity of at least one occupant in the vehicle;
determine access level information based at least in part on a tiered encrypted permissions structure for controlling access to the vehicle by the at least one detected occupant identity; and
provide the at least one detected occupant access to the vehicle based upon the access level information.

13. The vehicle of claim 12, wherein the at least one detected occupant access to the vehicle is limited based upon the access level information.

14. The vehicle of claim 12, wherein the at least one processor configured to access the at least one memory is further configured to record vehicle use information.

15. The vehicle of claim 14, wherein the at least one processor configured to access the at least one memory is further configured to award the at least one detected occupant vehicle use credits based in part on the vehicle use information.

16. The vehicle of claim 15, wherein at least one processor configured to access the at least one memory is further configured to grant additional functionality of the vehicle based at least in part on the credits awarded.

17. The vehicle of claim 15, wherein the at least one processor configured to access the at least one memory is further configured to report the vehicle use information to at least one individual based upon a reporting rule.
